(19) United States
(12) Patent Application Publication
(10) Pub. No.: US 2025/0246944 A1
(43) Pub. Date: Jul. 31, 2025

(54) INTEGRATED CIRCUIT, WIRELESS POWER TRANSMISSION DEVICE, AND OPERATING METHOD OF WIRELESS POWER TRANSMISSION DEVICE

(71) Applicant: SAMSUNG ELECTRONICS CO., LTD., Suwon-si (KR)

(72) Inventors: Hansol KIM, Suwon-si (KR); Jaekyu KIM, Suwon-si (KR); Sungwoo MOON, Suwon-si (KR)

(73) Assignee: SAMSUNG ELECTRONICS CO., LTD., Suwon-si (KR)

(21) Appl. No.: 19/005,578

(22) Filed: Dec. 30, 2024

(30) Foreign Application Priority Data
Jan. 26, 2024 (KR) 10-2024-0012671
May 31, 2024 (KR) 10-2024-0071816

(51) Int. Cl. H02J 50/80; H02J 50/12

(52) U.S. Cl. CPC H02J 50/80; H02J 50/12

(57) ABSTRACT

An integrated circuit includes: a voltage divider circuit configured to scale a voltage level of an input signal; an envelope detection circuit configured to output an envelope signal corresponding to an envelope of the scaled input signal and output an envelope signal; a differentiator circuit configured to differentiate the envelope signal and output a differential signal; a filtering circuit configured to output a filtered signal by low-pass filtering the differential signal based on a reference frequency; and a comparison circuit configured to output a comparison result signal corresponding to the input signal based on a result of comparing a voltage level of the filtered signal with a reference voltage.

### CROSS-REFERENCE TO RELATED APPLICATION

This application is based on and claims priority under 35 USC § 119 to Korean Patent Application Nos. 10-2024-0012671, filed on Jan. 26, 2024 and 10-2024-0071816, filed on May 31, 2024, in the Korean Intellectual Property Office, the disclosure of which is incorporated herein by reference in its entirety.

### BACKGROUND

The disclosure relates to wireless power transfer, and more particularly, to an integrated circuit including a demodulator using a differentiator in wireless power transfer, a wireless power transmission device, and an operating method of the wireless power transmission device.

Wireless power transfer or wireless energy transmission may refer to the transmission of energy in which a transmitter provides power wirelessly and a receiver receives power wirelessly. When there are difficulties in applying wired power transfer or when wireless power transfer is more convenient, wireless power transfer may be adopted. In wireless power transfer, power transfer may use magnetic and/or electromagnetic fields between a transmitter and a receiver. The transmitter may communicate with the receiver for wireless power transfer. In particular, the receiver may transmit charging state information about the device to the transmitter to provide the transmitter with feedback on the power provided from the transmitter.

### SUMMARY

The disclosure provides an integrated circuit (IC) for minimizing the use of external elements constituting a demodulator in a wireless power transmission device, thereby minimizing the production costs of the demodulator and the area occupied by the demodulator in a board on which the IC is mounted, a wireless power transmission device, and an operating method of the wireless power transmission device.

The technical problems of the disclosure are not limited to the technical problems mentioned above, and other technical problems not mentioned may be clearly understood by those skilled in the art from the description below.

According to an aspect of the inventive concept, there is provided an integrated circuit which may include: a voltage divider circuit configured to scale a voltage level of an input signal; an envelope detection circuit configured to output an envelope signal corresponding to an envelope of the scaled input signal and output an envelope signal; a differentiator circuit configured to differentiate the envelope signal and output a differential signal; a filtering circuit configured to output a filtered signal by low-pass filtering the differential signal based on a reference frequency; and a comparison circuit configured to output a comparison result signal corresponding to the input signal based on a result of comparing a voltage level of the filtered signal with a reference voltage.

According to another aspect of the inventive concept, there is provided a wireless power transmission device configured to supply wireless power to a wireless power receiving device, which may include: an inverter circuit configured to generate a charging signal having a first frequency based on a power supply voltage; a power transmission resonant circuit magnetically coupled to the wireless power receiving device; and a demodulation circuit configured to receive, as an input signal, the charging signal whose amplitude changes based on a change in impedance of the wireless power receiving device and output a comparison result signal based on the changed amplitude of the input signal, wherein the demodulation circuit includes a differentiator circuit configured to differentiate an envelope signal corresponding to an envelope of the input signal and output a differential signal.

According to another aspect of the inventive concept, there is provided an operating method of a wireless power transmission device configured to supply wireless power to a wireless power receiving device, which may include: receiving, as an input signal, a charging signal whose amplitude changes based on a change in impedance of the wireless power receiving device; scaling a voltage level of the input signal, detecting an envelope of the scaled input signal and outputting an envelope signal corresponding to the detected envelope; differentiating the envelope signal and outputting a differential signal; filtering the differential signal based on a reference frequency and outputting a filtered signal; and outputting a comparison result signal corresponding to the input signal based on a result of comparing a voltage level of the filtered signal with a voltage level of a reference voltage.

### BRIEF DESCRIPTION OF DRAWINGS

Embodiments will be more clearly understood from the following detailed description taken in conjunction with the accompanying drawings in which:

FIG. 1 is a block diagram illustrating a wireless power transmission system according to one or more embodiments;

FIGS. 2A and 2B are circuit diagrams illustrating a wireless power transmission system according to one or more embodiments;

FIG. 3 is a diagram illustrating capacitive modulation according to one or more embodiments;

FIG. 4 is a diagram illustrating capacitive modulation according to one or more embodiments;

FIGS. 5A and 5B are diagrams illustrating a differentiator according to one or more embodiments;

FIG. 6 is a block diagram illustrating a demodulator according to one or more embodiments;

FIG. 7 is a circuit diagram illustrating a demodulator according to one or more embodiments;

FIG. 8 illustrates waveforms of signals occurring inside a demodulator according to one or more embodiments;

FIG. 9 is a circuit diagram illustrating a demodulator according to one or more embodiments;

FIG. 10 illustrates waveforms of signals generated inside a demodulator according to one or more embodiments;

FIG. 11 is a flowchart illustrating an operating method of a wireless power transmission device according to one or more embodiments; and

FIG. 12 is a diagram illustrating a method of sharing power between electronic devices, according to various embodiments.

### DETAILED DESCRIPTION

Hereinafter, embodiments are described in detail with reference to the accompanying drawings. The embodiments described herein are non-limiting example embodiments, and thus, the disclosure is not limited thereto and may be realized in various other forms. Those components that are the same or are in correspondence are rendered the same reference numeral and redundant.

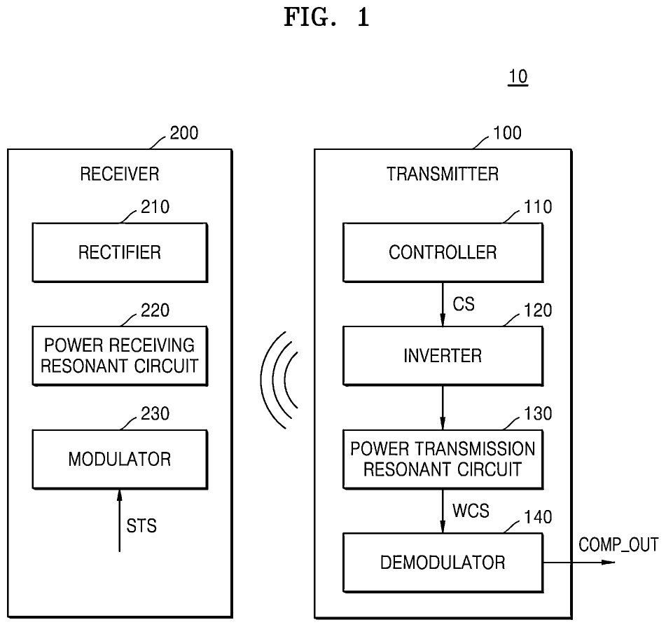

FIG. 1 is a block diagram illustrating a wireless power transmission system 10 according to one or more embodiments.

Referring to FIG. 1, the wireless power transmission system 10 may include a transmitter 100 and a receiver 200. In this specification, the transmitter 100 or a device including the transmitter 100 as a component may be referred to as a wireless power transmission device, and the receiver 200 or a device including the receiver 200 as a component may be referred to as a wireless power receiving device.

In one or more embodiments, the wireless power transmission device may refer to any device that provides power wirelessly, and may include, as non-limiting examples thereof, wireless chargers for portable devices, wireless chargers for electric vehicles, smartphones, wearable devices, tablet personal computers (PCs), laptop computers, and auxiliary batteries. The wireless power receiving device may refer to any device that receives power wirelessly, and may include, as non-limiting examples, smartphones, tablet PCs, laptop computers, wearable devices, etc.

The transmitter 100 may transmit power wirelessly, and the receiver 200 may receive power wirelessly. Wireless power transfer may occur in a variety of ways. For example, wireless power transfer may occur through two inductors coupled by magnetic induction. While magnetic induction may provide high power transfer efficiency, it may be necessary for two inductors to be close to each other due to a magnetic field around a coil which decreases significantly with increasing distance. A resonant inductive coupling method utilizes resonance between two resonant circuits, and a distance between the two resonant circuits may be increased. Hereinafter, wireless power transfer based on magnetic induction is mainly described, but it will be understood that embodiments are not limited thereto.

When the transmitter 100 supplies wireless power to the receiver 200, the transmitter 100 and the receiver 200 may follow a wireless charging standard of the wireless power consortium (WPC). For example, the wireless charging standard may be Qi or Qi2. However, without being limited thereto, and in another example, the transmitter 100 and the receiver 200 may follow the wireless charging standard of alliance for wireless power (A4WP) or power matters alliance (PMA).

The transmitter 100 may not only transmit wireless power but also receive a status signal STS from the receiver 200 through a non-contact method. The status signal STS may indicate charging state information about the receiver 200. The charging state information about the receiver 200 may include, for example, information on the remaining battery capacity of the receiver 200, information on whether the receiver 200 is fully charged, and heat generation information about the receiver 200. Here, the status signal STS may be a signal obtained by modulating the charging state information using amplitude shift keying (ASK). In one or more embodiments, a frequency of the status signal STS may be 2 kHz. In this specification, the status signal STS may be referred to as an ASK signal.

In one or more embodiments, the status signal STS provided from the receiver 200 to the transmitter 100 may be provided through capacitive modulation. For example, the modulator 230 of the receiver 200 may adjust impedance of the receiver 200 based on a logic level of the status signal STS to be sent to the transmitter 100. As the impedance of the receiver 200 is adjusted, a resonant frequency of the receiver 200 may change. The transmitter 100 may acquire the status signal STS by demodulating a change in power. For example, as the impedance of the receiver 200 is adjusted, a change in the amount of power provided from the transmitter 100 to the receiver 200 may correspond to a change in the amplitude of a charging signal WCS. When the modulator 230 of the receiver 200 performs a modulation operation based on the status signal STS, the charging signal WCS may be capacitively modulated. In this specification, the capacitively modulated charging signal WCS may be referred to as a capacitive modulation signal. The charging signal WCS may be applied to a demodulator 140 of the transmitter 100 and demodulated through the demodulator 140.

The transmitter 100 may include a controller 110, an inverter 120, a power transmission resonant circuit 130, and the demodulator 140.

The controller 110 may transmit power to the receiver 200 through the power transmission resonant circuit 130 by controlling the inverter 120 through a control signal CS. According to control by the controller 110, a signal output from the inverter 120 may be the charging signal WCS. The power provided by the power transmission resonant circuit 130 may depend on the charging signal WCS. The transmitter 100 may provide power to the receiver 200 by generating electromagnetic waves that vibrate at the resonant frequency of the receiver 200. In some embodiments, the controller 110 may be referred to as a control circuit.

The charging signal WCS may be a signal having a higher frequency than the status signal STS. In one or more embodiments, the frequency of the charging signal WCS may be between 100 kHz and 200 kHz.

The inverter 120 may generate the charging signal WCS based on a power supply voltage. The frequency of the charging signal WCS provided by the inverter 120 to the power transmission resonant circuit 130 may be the same as the resonant frequency of a power receiving resonant circuit 220 (for example, the resonant frequency when the impedance of the power receiving resonant circuit 220 does not change). The power receiving resonant circuit 220 may include an inductor and a capacitor connected in series, and when the inductor has inductance L and the capacitor has capacitance C, the resonant frequency fo of the power receiving resonant circuit 220 may be calculated as expressed by Equation 1 below.

$${f}_{0} = \frac{1}{2 π \sqrt{LC}} \qquad [ Equation 1 ]$$

In one or more embodiments, an inductor and a capacitor of the power transmission resonant circuit 130 may have inductance and capacitance, respectively, to have the same resonant frequency as that of the power receiving resonant circuit 220. In some embodiments, the power transmission resonant circuit 130 may further include a resistor connected in series to the inductor or capacitor.

In one or more embodiments, the transmitter 100 may be magnetically coupled to the receiver 200 through the power transmission resonant circuit 130. For example, the power transmission resonant circuit 130 may be magnetically connected to the power receiving resonant circuit 220.

In some embodiments, the inverter 120 may be referred to as an inverter circuit.

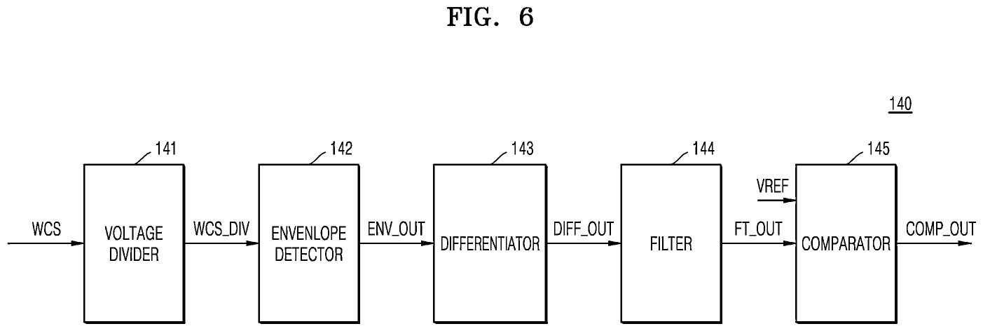

The charging signal WCS may be applied to the demodulator 140. In this specification, the charging signal WCS applied to the demodulator 140 may be referred to as an input signal. In order to detect the status signal STS received from the receiver 200, the demodulator 140 may filter frequency components excluding a frequency component of the status signal STS. An output signal of the demodulator 140 may be a comparison result signal COMP_OUT. The comparison result signal COMP_OUT may be a signal representing the same information as the status signal STS. A series of processes in which the demodulator 140 detects the status signal STS from the charging signal WCS is described below with reference to FIG. 6.

In one or more embodiments, all elements constituting the demodulator 140 may be mounted on one chip.

In one or more embodiments, only some of the elements constituting the demodulator 140 may be mounted on the outside of the chip, and the rest may all be mounted on one chip.

In some embodiments, the demodulator 140 may be referred to as a demodulation circuit.

The receiver 200 may include a rectifier 210, the power receiving resonant circuit 220, and a modulator 230.

When the transmitter 100 generates an electromagnetic wave that vibrates at the resonant frequency of the power receiving resonant circuit 220 for power transmission, a voltage, for example, an alternating current (AC) voltage, that vibrates at the resonant frequency may be generated in the power receiving resonant circuit 220 of the receiver 200. The rectifier 210 may rectify the AC voltage to generate a rectified voltage (i.e., a resultant voltage). The rectified voltage may be used to provide power to components of the receiver 200 and may be output to the outside of the receiver 200 and used to provide power to components of a device including the receiver 200. In some embodiments, the rectifier 210 may be a full-wave rectifier or a half-wave rectifier and may include diodes. In some embodiments, the rectifier 210 may be referred to as a rectifier circuit.

The modulator 230 may include a switch and a capacitor. The modulator 230 may adjust impedance of the power receiving resonant circuit 220 by electrically connecting the capacitor to the power receiving resonant circuit 220 or cutting off the electrical connection to the power receiving resonant circuit 220 through the switch. In some embodiments, the modulator 230 may be referred to as a modulation circuit.

According to one or more embodiments, by using a differentiator in the demodulator 140, capacitance of the capacitor required to implement the demodulator 140 may be reduced. As the capacitance of the capacitor is reduced, all the components constituting the demodulator 140 may be mounted on one chip or the use of external elements may be reduced. Through this, the area occupied by the demodulator 140 in the transmitter 100 may be reduced.

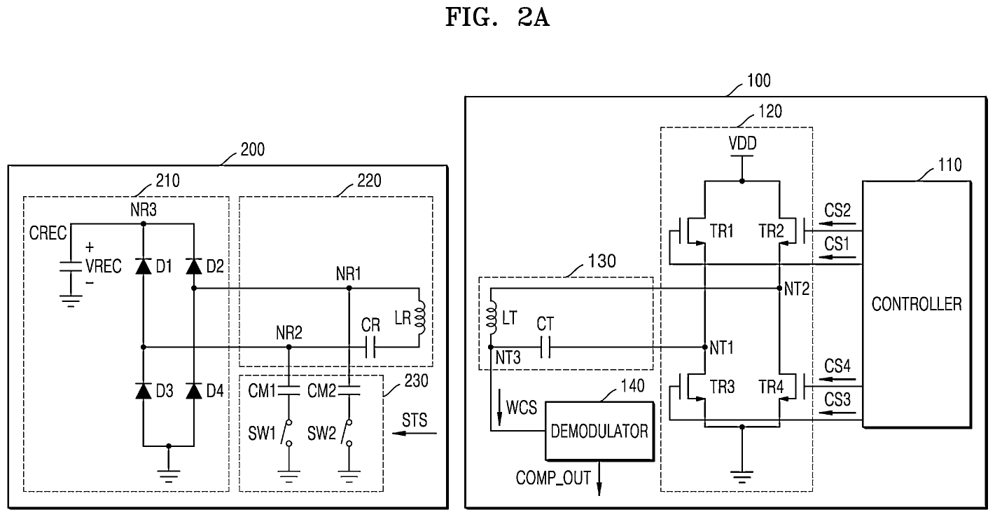

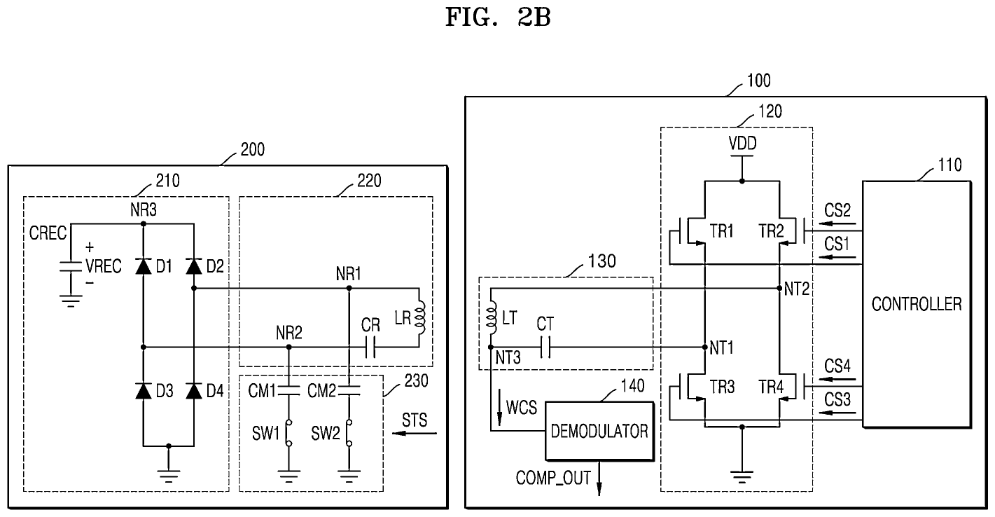

FIGS. 2A and 2B are circuit diagrams illustrating the wireless power transmission system 10 according to one or more embodiments. FIG. 2A is a diagram illustrating a case in which the impedance of the receiver 200 as viewed from the transmitter 100 is not changed by the modulator 230, and FIG. 2B is a diagram illustrating a case in which the impedance of the receiver 200 as viewed from the transmitter 100 is changed by the modulator 230. FIG. 2 may be described with reference to FIG. 1, and redundant descriptions may be omitted.

Referring to FIGS. 2A and 2B, the wireless power transmission system 10 may include the transmitter 100 and the receiver 200.

The transmitter 100 may include the controller 110, the inverter 120, the power transmission resonant circuit 130, and the demodulator 140.

The controller 110 may generate a first control signal CS1, a second control signal CS2, a third control signal CS3, and a fourth control signal CS4. The controller 110 may control the inverter 120 through a first control signal CS1, a second control signal CS2, a third control signal CS3, and a fourth control signal CS4.

In one or more embodiments, the controller 110 may turn on or turn off a first transistor TR1 through the first control signal CS1. The controller 110 may turn on or turn off a second transistor TR2 through the second control signal CS2. The controller 110 may turn on or turn off a third transistor TR3 through the third control signal CS3. The controller 110 may turn on or turn off a fourth transistor TR4 through the fourth control signal CS4.

The inverter 120 may include the first transistor TR1, the second transistor TR2, the third transistor TR3, and the fourth transistor TR4. Gates of the first transistor TR1 and the second transistor TR2 may be electrically connected to the controller 110. Drains of the first transistor TR1 and the second transistor TR2 may be electrically connected to a power supply voltage VDD. A source of the first transistor TR1 and a drain of the third transistor TR3 may be electrically connected to a first node NT1. A source of the second transistor TR2 and a drain of the fourth transistor TR4 may be electrically connected to a second node NT2. Gates of the third transistor TR3 and TR4 may be electrically connected to the controller 110. Sources of the third transistor TR3 and TR4 may be electrically connected to the ground.

The power transmission resonant circuit 130 may include a transmission inductor LT and a transmission capacitor CT. One end of the transmission inductor LT may be electrically connected to the second node NT2, and the other end of the transmission inductor LT may be electrically connected to a third node NT3. One end of the transmission capacitor CT may be electrically connected to the third node NT3, and the other end of the transmission capacitor CT may be electrically connected to the first node NT1. The power transmission resonant circuit 130 may provide power to the receiver 200, based on a signal provided from the inverter 120.

In one or more embodiments, the controller 110 may turn on the first transistor TR1 and the fourth transistor TR4 through the first control signal CS1 and the fourth control signal CS4, respectively, and turn off the second transistor TR2 and the third transistor TR3 through the second control signal CS2 and the third control signal CS3, respectively.

In one or more embodiments, the controller 110 may turn off the first transistor TR1 and the fourth transistor TR4 through the first control signal CS1 and the fourth control signal CS4, respectively, and turn on the second transistor TR2 and the third transistor TR3 through the second control signal CS2 and the third control signal CS3, respectively.

The demodulator 140 may be electrically connected to the power transmission resonant circuit 130 through the third node NT3.

The receiver 200 may include the rectifier 210, the power receiving resonant circuit 220, and the modulator 230.

The rectifier 210 may include a first diode D1, a second diode D2, a third diode D3, a fourth diode D4, and a rectifying capacitor CREC. Cathodes of the first diode D1 and the second diode D2 may be electrically connected to a third node NR3. An anode of the first diode D1 and a cathode of the third diode D3 may be electrically connected to a second node NR2. An anode of the second diode D2 and a cathode of the fourth diode D4 may be electrically connected to a first node NR1. Anodes of the third diode D3 and the fourth diode D4 may be electrically connected to the ground. One end of the rectifying capacitor CREC may be electrically connected to the third node NR3. The other end of the rectifying capacitor CREC may be electrically connected to the ground. The rectifier 210 may rectify the AC voltage generated at the first node NR1 and the second node NR2, and generate a rectified voltage VREC.

The power receiving resonant circuit 220 may include a receiving inductor LR and a receiving capacitor CR. One end of the receiving inductor LR may be electrically connected to the first node NR1, and the other end of the receiving inductor LR may be electrically connected to the receiving capacitor CR. One end of the receiving capacitor CR may be electrically connected to the receiving inductor LR, and the other end of the receiving capacitor CR may be electrically connected to the second node NR2.

Due to electromagnetic waves induced by the power transmission resonant circuit 130, an AC voltage that oscillates at the resonant frequency of the power receiving resonant circuit 220 may be generated at the first node NR1 and the second node NR2.

The modulator 230 may include a first modulation capacitor CM1, a second modulation capacitor CM2, a first switch SW1, and a second switch SW2.

One end of the first modulation capacitor CM1 may be electrically connected to the second node NR2, and the other end of the first modulation capacitor CM1 may be electrically connected to the first switch SW1. One end of the first switch SW1 may be electrically connected to the first modulation capacitor CM1, and the other end of the first switch SW1 may be electrically connected to the ground.

One end of the second modulation capacitor CM2 may be electrically connected to the first node NR1, and the other end of the second modulation capacitor CM2 may be electrically connected to the second switch SW2. One end of the second switch SW2 may be electrically connected to the second modulation capacitor CM2, and the other end of the second switch SW2 may be electrically connected to the ground.

The modulator 230 may control the first switch SW1 and the second switch SW2 based on the status signal STS that the receiver 200 wants to provide to the transmitter 100.

Referring to FIG. 2A, when the first switch SW1 and the second switch SW2 are turned off, impedance of the receiver 200 as viewed from the transmitter 100 may be a first impedance. Referring to FIG. 2B, when the first switch SW1 and the second switch SW2 are turned on, the impedance of the receiver 200 as viewed from the transmitter 100 may be a second impedance. When the impedance of the receiver 200 as viewed from the transmitter 100 is the first impedance, a resonant frequency of the receiver 200 may match a resonant frequency of the charging signal WCS. Here, an amplitude of the charging signal WCS may be a first amplitude. When the impedance of the receiver 200 as viewed from the transmitter 100 is the second impedance, the resonant frequency of the receiver 200 may not match the resonant frequency of the charging signal WCS, and in this case, the amplitude of the charging signal WCS may be the second amplitude, and the second amplitude may have a value smaller than that of the first amplitude.

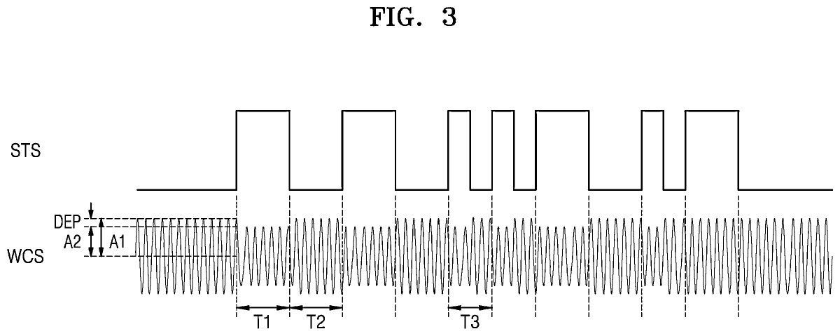

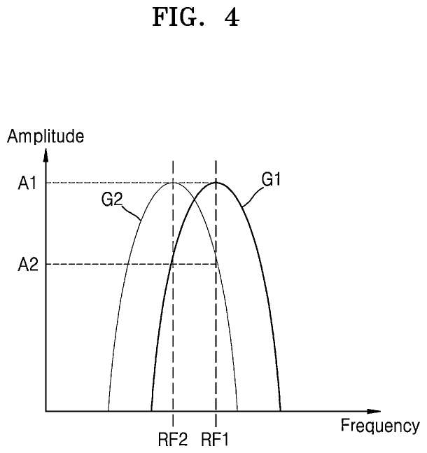

FIG. 3 is a diagram illustrating capacitive modulation according to one or more embodiments. FIG. 4 is a diagram illustrating capacitive modulation according to one or more embodiments. FIGS. 3 and 4 may be described with reference to FIGS. 1, 2A and 2B, and redundant descriptions may be omitted.

Referring to FIG. 3, the charging signal WCS may oscillate according to the resonant frequency of the power receiving resonant circuit (220 in FIG. 2A). The resonant frequency may be, for example, a value between 100 kHz and 200 kHz.

The status signal STS may be a signal transmitted from the receiver (200 in FIG. 2B) to the transmitter (100 in FIG. 2B). The status signal STS may be a signal modulated in ASK. A frequency of the status signal STS may be lower than a frequency of the charging signal WCS. For example, the frequency of the status signal STS may be 2 kHz.

In one or more embodiments, when a logic level is maintained for one period of the status signal STS, a value corresponding to one period of the status signal STS may be a first value (e.g., “0”). For example, because the logic level of the status signal STS does not change in a first time period T1, a value corresponding to the first time period T1 of the status signal STS may be a first value. For example, because the logic level of the status signal STS does not change in a second time period T2, a value corresponding to the second time period T2 of the status signal STS may be the first value.

In one or more embodiments, when the logic level is not maintained during one period of the status signal STS, a value corresponding to one period of the status signal STS may be a second value (e.g., “1”). For example, because the logic level of the status signal STS changes from high level to low level in the third time period T3, a value corresponding to a third time period T3 of the status signal STS may be the second value.

The charging signal WCS may be a signal modulated based on the status signal STS. By demodulating the charging signal WCS, the demodulator (140 in FIG. 2B) may detect the status signal STS. The amplitude of the charging signal WCS may change depending on the logic level of the status signal STS.

In one or more embodiments, in a first time period T1, when the logic level of the status signal STS is a low level, the amplitude of the charging signal WCS in the first time period T1 may be a second amplitude A2.

In a second time period T2, when the logic level of the status signal STS is a high level, the amplitude of the charging signal WCS in the second time period T2 may be a first amplitude A1. The first amplitude A1 may be greater than the second amplitude A2. That is, the amplitude of the charging signal WCS in the second time period T2 may be greater than the amplitude of the charging signal WCS in the first time period T1. Here, the difference between the first amplitude A1 and the second amplitude A2 may correspond to an amplitude difference DEP.

FIG. 4 is a graph illustrating the amplitude of the charging signal WCS over the frequency of the charging signal WCS. The horizontal axis of FIG. 4 represents the frequency of the charging signal WCS, and the vertical axis of FIG. 4 represents the amplitude of the charging signal WCS.

Referring to FIGS. 2A and 4, a first graph G1 may correspond to the charging signal WCS when the first switch SW1 and the second switch SW2 of the modulator 230 are turned off. A first resonant frequency RF1 may correspond to a resonant frequency of the power receiving resonant circuit 220 when the first switch SW1 and the second switch SW2 of the modulator 230 are turned off.

Referring to FIGS. 2B and 4, a second graph G2 may correspond to a graph when the first switch SW1 and the second switch SW2 of the modulator 230 are turned on. The second resonant frequency RF2 may correspond to a resonant frequency of the power receiving resonant circuit 220 when the first switch SW1 and the second switch SW2 of the modulator 230 are turned on.

When the frequency of the charging signal WCS matches the resonant frequency of the power receiving resonant circuit 220, the amplitude of the charging signal WCS may be the first amplitude A1. For example, when the frequency of the charging signal WCS matches the resonant frequency of the power receiving resonant circuit 220, the amount of power provided by the transmitter 100 to the receiver 200 may be the largest.

In one or more embodiments, it is assumed that the frequency of the charging signal WCS is the first resonant frequency RF1. Referring to FIGS. 2B, 3, and 4 together, when the receiver 200 transmits the status signal STS corresponding to the first time period T1 to the transmitter 100, the modulator 230 of the receiver 200 may turn on the first switch SW1 and the second switch SW2. Here, because the first modulation capacitor CM1 and the second modulation capacitor CM2 are electrically connected to the power receiving resonant circuit 220, the impedance of the power receiving resonant circuit 220 may change. As the impedance of the power receiving resonant circuit 220 changes, the resonant frequency of the power receiving resonant circuit 220 may change from the first resonant frequency RF1 to the second resonant frequency RF2. Here, because the frequency of the charging signal WCS still corresponds to the first resonant frequency RF1, the frequency of the charging signal WCS may not match the resonant frequency of the power receiving resonant circuit 220. The amplitude of the charging signal WCS may be the second amplitude A2.

In one or more embodiments, it is assumed that the frequency of the charging signal WCS is the first resonant frequency RF1. The description is given with reference to FIGS. 2A, 3, and 4 together. When the receiver 200 transmits the status signal STS corresponding to the second time period T2 to the transmitter 100, the modulator 230 of the receiver 200 may turn off the first switch SW1 and the second switch SW2. Here, because the first modulation capacitor CM1 and the second modulation capacitor CM2 are not electrically connected to the power receiving resonant circuit 220, the resonant frequency of the power receiving resonant circuit 220 may be the first resonant frequency RF1. Here, because the frequency of the charging signal WCS still corresponds to the first resonant frequency RF1, the frequency of the charging signal WCS may match the resonant frequency of the power receiving resonant circuit 220. The amplitude of the charging signal WCS may be the first amplitude A1.

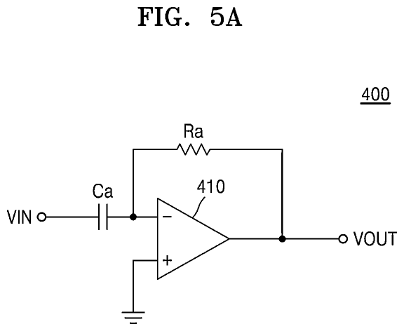

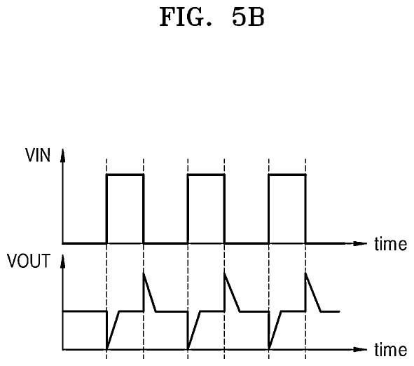

FIGS. 5A and 5B are diagrams illustrating a differentiator 400 according to one or more embodiments. For example, FIG. 5A illustrates a circuit diagram of the differentiator 400. FIG. 5B illustrates a graph illustrating an output voltage VOUT according to an input voltage VIN applied to the differentiator 400. According to one or more embodiments, the differentiator 400 may be included in the demodulator 140 of the transmitter 100 shown in FIGS. 1, 2A and 2B.

Referring to FIG. 5A, the differentiator 400 may include a capacitor Ca, a resistor Ra, and an operational amplifier 410. The differentiator 400 may output the output voltage VOUT by differentiating the input voltage VIN.

The input voltage VIN may be applied to one end of the capacitor Ca, and the other end of the capacitor Ca may be electrically connected to an inverting input terminal of the operational amplifier 410. One end of the resistor Ra may be electrically connected to the inverting input terminal of the operational amplifier 410, and the other end of the resistor Ra may be electrically connected to an output terminal of the operational amplifier 410. A non-inverting input terminal of the operational amplifier 410 may be electrically connected to the ground.

The output voltage VOUT output to the output terminal of the operational amplifier 410 may be calculated as expressed in Equation 2 below.

$$VOUT = - ( Ra \cdot Ca ) \cdot \frac{dVIN}{dt} \qquad [ Equation 2 ]$$

In this specification, the output voltage VOUT of the differentiator 400 may be referred to as a differentiator output signal, and the input voltage VIN of the differentiator 400 may be referred to as a differentiator input signal.

Referring to FIG. 5B, a graph of the input voltage VIN of the differentiator 400 and a graph of the output voltage VOUT of the differentiator 400 are shown. The output voltage VOUT may be obtained by calculating the input voltage VIN according to Equation 2.

FIG. 6 is a block diagram illustrating the demodulator 140 according to one or more embodiments. FIG. 6 may be described with reference to FIGS. 1 to 5B, and redundant descriptions may be omitted.

The demodulator 140 may include a voltage divider 141, an envelope detector 142, a differentiator 143, a filter 144, and a comparator 145. The demodulator 140 may correspond to the demodulator 140 of FIGS. 1, 2A and 2B. The differentiator 143 in FIG. 6 may correspond to the differentiator 400 in FIG. 5A.

In one or more embodiments, the demodulator 140 may be an integrated circuit in which the voltage divider 141, the envelope detector 142, the differentiator 143, the filter 144, and the comparator 145 are all mounted on one chip.

The voltage divider 141 may receive the charging signal WCS. The voltage divider 141 may scale the amplitude of the received charging signal WCS. For example, when the amplitude of the charging signal WCS is A, the voltage divider 141 may scale the amplitude of the charging signal WCS by A/N (N is a real number of 1 or greater). The voltage divider 141 may provide the scaled charging signal WCS_DIV to the envelope detector 142. In this specification, the charging signal WCS input to the demodulator 140 (for example, the charging signal WCS input to the voltage divider 141) may be referred to as an input signal. In addition, the scaled charging signal WCS_DIV output from the voltage divider 141 may be referred to as a scaled input signal. In some embodiments, the voltage divider 141 may be referred to as a voltage divider circuit.

The envelope detector 142 may detect an envelope of the scaled charging signal WCS_DIV received from the voltage divider 141. The envelope detector 142 may provide an envelope signal ENV_OUT corresponding to the detected envelope to the differentiator 143. In some embodiments, the envelope detector 142 may be referred to as an envelope detection circuit.

The differentiator 143 may output a differential signal DIFF_OUT corresponding to the envelope signal ENV_OUT received from the envelope detector 142. In this specification, a differential signal may refer to a signal corresponding to a small time change rate of a signal input to the differentiator 143. That is, the differential signal DIFF_OUT may be a differentiator output signal calculated according to Equation 2 described above using the envelope signal ENV_OUT as the differentiator input signal.

In some embodiments, the differentiator 143 may amplify the magnitude of the differential signal DIFF_OUT corresponding to the envelope signal ENV_OUT, and output the same.

In some embodiments, the differentiator 143 may be referred to as a differentiator circuit.

The filter 144 may filter noise of the differential signal DIFF_OUT received from the differentiator 143 based on a reference frequency. The filter 144 may output a signal obtained by removing noise from the differential signal DIFF_OUT, that is, a filtered signal FT_OUT.

In one or more embodiments, the filter 144 may be a low-pass filter allowing only a signal having a frequency lower than the reference frequency to pass therethrough. Because the frequency of the status signal STS is lower than the frequency of the charging signal WCS, the filter 144 may be designed to allow the frequency corresponding to the status signal STS to pass therethrough and block the frequency corresponding to the charging signal WCS. For example, the filter 144 may be a filter designed to allow only a signal having a frequency of 50 kHz or less to pass therethrough, and in this case, the reference frequency may be 50 kHz.

In some embodiments, the filter 144 may invert the differential signal DIFF_OUT and amplify the magnitude of the inverted differential signal DIFF_OUT.

In some embodiments, the filter 144 may be referred to as a filter circuit.

The comparator 145 may output a comparison result signal COMP_OUT corresponding to a result of comparing the filtered signal FT_OUT received from the filter 144 with a reference voltage VREF. The comparison result signal COMP_OUT may correspond to the status signal STS that the receiver (200 in FIG. 1) wants to transmit to the transmitter (100 in FIG. 1). That is, the comparison result signal COMP_OUT may include status information about the receiver 200. The comparison result signal COMP_OUT output by the comparator 145 may be an output signal of the demodulator 140. In this specification, the comparison result signal COMP_OUT may be referred to as an output signal.

In some embodiments, the comparator 145 may be referred to as a comparison circuit.

In one or more embodiments, the reference voltage VREF may be a voltage generated by the receiver 200.

In one or more embodiments, the comparator 145 may be a Schmitt Trigger circuit. That is, the comparator 145 may have hysteresis characteristics. For example, the filtered signal FT_OUT, which is an input voltage, is lower than a first threshold voltage, the comparator 145 may output a comparison result signal COMP_OUT having a first logic level. Also, for example, when the filtered signal FT_OUT, which is an input voltage, is higher than a second threshold voltage, the comparator 145 may output a comparison result signal COMP_OUT having a second logic level. When the filtered signal FT_OUT, which is an input voltage, is higher than the first threshold voltage and lower than the second threshold voltage, the logic level of the comparison result signal COMP_OUT may not change (that is, when an immediately preceding logic level of the signal COMP_OUT is the first logic level, the logic level of the comparison result signal COMP_OUT may be maintained as the first logic level, and when the immediately preceding logic level of the comparison result signal COMP_OUT is the second logic level, the logic level of the comparison result signal COMP_OUT may be maintained as the second logic level). Here, the first threshold voltage may be lower than the reference voltage VREF, and the second threshold voltage may be higher than the reference voltage VREF.

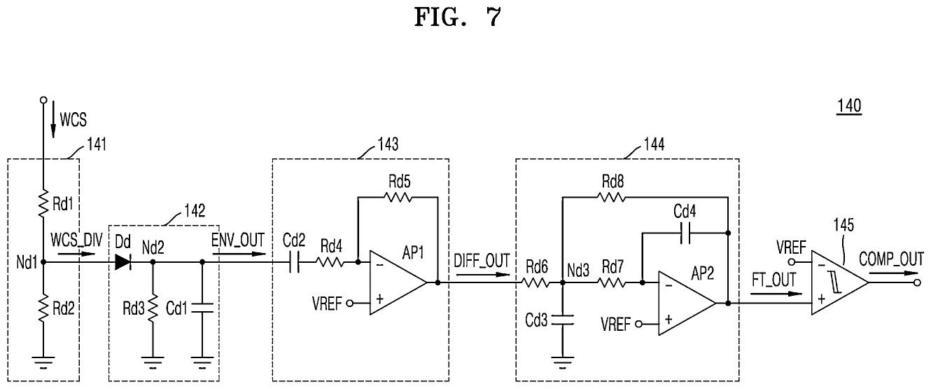

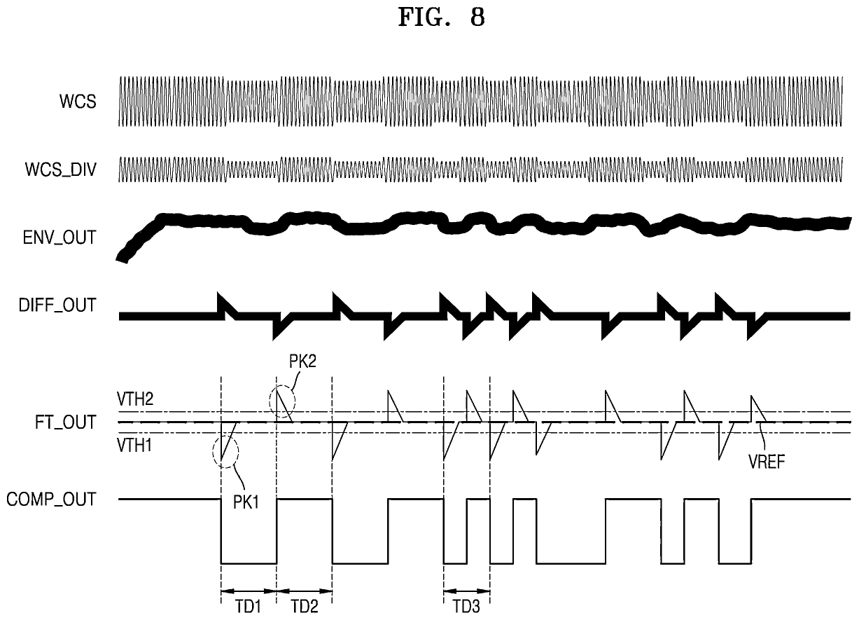

FIG. 7 is a circuit diagram illustrating the demodulator 140 according to one or more embodiments. FIG. 8 illustrates waveforms of signals occurring inside the demodulator 140 according to one or more embodiments. FIGS. 7 and 8 may be described with reference to FIGS. 1 to 6, and redundant descriptions may be omitted.

Referring to FIGS. 7 and 8, the demodulator 140 of FIG. 7 may correspond to the demodulator 140 of FIG. 6.

The voltage divider 141 may include a first resistor Rd1 and a second resistor Rd2. The charging signal WCS may be applied to one end of the first resistor Rd1, and the other end of the first resistor Rd1 may be electrically connected to a first node Nd1. One end of the second resistor Rd2 may be electrically connected to the first node Nd1, and the other end of the second resistor Rd2 may be electrically connected to the ground.

In one or more embodiments, the size of the first resistor Rd1 may be a voltage N-1 (N is a real number of 1 or greater) times greater than the size of the second resistor Rd2. The voltage divider 141 may scale the amplitude of the charging signal WCS as expressed by Equation 3 below to output a scaled charging signal WCS_DIV of which the amplitude is scaled. Here, the size of the first resistor Rd1 is assumed to be (N-1)R, and the size of the second resistor Rd2 is assumed to be R.

$$WCS\_DIV = \frac{R}{( N - 1 ) R + R} \cdot WCS = \frac{1}{N} \cdot WCS \qquad [ Equation 3 ]$$

The envelope detector 142 may include a diode Dd, a third resistor Rd3, and a first capacitor Cd1. The envelope detector 142 may receive the scaled charging signal WCS_DIV and output an envelope signal ENV_OUT. The scaled charging signal WCS_DIV may be applied to one end of the diode Dd. The other end of the diode Dd may be electrically connected to the second node Nd2. One end of the third resistor Rd3 may be electrically connected to the second node Nd2, and the other end of the third resistor Rd3 may be electrically connected to the ground. One end of the first capacitor Cd1 may be electrically connected to the second node Nd2, and the other end of the first capacitor Cd1 may be electrically connected to the ground.

The differentiator 143 may include a second capacitor Cd2, a fourth resistor Rd4, a fifth resistor Rd5, and a first operational amplifier AP1. One end of the second capacitor Cd2 may be electrically connected to the second node Nd2, and the scaled charging signal WCS_DIV may be applied to the second capacitor Cd2 through the second node Nd2. The other end of the second capacitor Cd2 may be electrically connected to one end of the fourth resistor Rd4. The other end of the fourth resistor Rd4 may be electrically connected to an inverting input terminal of the first operational amplifier AP1. One end of the fifth resistor Rd5 may be electrically connected to the inverting input terminal of the first operational amplifier AP1, and the other end of the fifth resistor Rd5 may be electrically connected to an output terminal of the first operational amplifier AP1. The reference voltage VREF may be applied to a non-inverting input terminal of the first operational amplifier AP1. The first operational amplifier AP1 may output a differential signal DIFF_OUT.

The filter 144 may include a sixth resistor Rd6, a seventh resistor Rd7, an eighth resistor Rd8, a third capacitor Cd3, a fourth capacitor Cd4, and a second operational amplifier AP2. One end of the sixth resistor Rd6 may be electrically connected to the output terminal of the first operational amplifier AP1, and the other end of the sixth resistor Rd6 may be electrically connected to a third node Nd3. One end of the third capacitor Cd3 may be electrically connected to the third node Nd3, and the other end of the third capacitor Cd3 may be electrically connected to the ground. One end of the seventh resistor Rd7 may be electrically connected to the third node Nd3, and the other end of the seventh resistor Rd7 may be electrically connected to an inverting input terminal of the second operational amplifier AP2. One end of the eighth resistor Rd8 may be electrically connected to the third node Nd3, and the other end of the eighth resistor Rd8 may be electrically connected to an output terminal of the second operational amplifier AP2. One end of the fourth capacitor Cd4 may be electrically connected to the inverting input terminal of the second operational amplifier AP2, and the other end of the fourth capacitor Cd4 may be electrically connected to the output terminal of the second operational amplifier AP2. The reference voltage VREF may be applied to a non-inverting input terminal of the second operational amplifier AP2. The second operational amplifier AP2 may output a filtered signal FT_OUT through the output terminal thereof.

The reference voltage VREF may be applied to the inverting input terminal of the comparator 145. The non-inverting input terminal of the comparator 145 may be electrically connected to the output terminal of the second operational amplifier AP2, and the filtered signal FT_OUT may be applied to the non-inverting input terminal of the comparator 145. The comparator 145 may compare the filtered signal FT_OUT with the reference voltage VREF and output a comparison result signal COMP_OUT to an output terminal thereof. The comparator 145 may have hysteresis characteristics.

In one or more embodiments, when the voltage level of the filtered signal FT_OUT is lower than a first threshold voltage VTH1, the comparison result signal COMP_OUT may have a first logic level. For example, referring to FIG. 8, the filtered signal FT_OUT has a first peaking signal PK1 that is smaller than the first threshold voltage VTH1 in a first time period TD1, so a logic level of the comparison result signal COMP_OUT in the first time period TD1 may be a first logic level.

In one or more embodiments, when the voltage level of the filtered signal FT_OUT is higher than a second threshold voltage VTH2, the comparison result signal COMP_OUT may have a second logic level. For example, referring to FIG. 8, the filtered signal FT_OUT has a second peaking signal PK2 greater than the second threshold voltage VTH2 in a second time period TD2, so the logic level of the comparison result signal COMP_OUT in the second time period TD2 may be the second logic level.

In one or more embodiments, when the voltage level of the filtered signal FT_OUT is higher than the first threshold voltage VTH1 and lower than the second threshold voltage VTH2, the logic level of the comparison result signal COMP_OUT may be maintained without change according to the hysteresis characteristic. For example, when the voltage level of the filtered signal FT_OUT having a voltage level lower than the first threshold voltage VTH changes to be higher than the first threshold voltage VTH1 and lower than the second threshold voltage VTH2 as in the first time period TD1, the logic level of the comparison result signal COMP_OUT may be maintained at the first logic level. Also, for example, when the voltage level of the filtered signal FT_OUT having a voltage level higher than the second threshold voltage VTH2 changes to be higher than the first threshold voltage VTH1 and lower than the second threshold voltage VTH2 as in the second time period TD2, the logic level of the comparison result signal COMP_OUT may be maintained at the second logic level.

In one or more embodiments, the comparison result signal COMP_OUT may represent the same information as the status signal STS (i.e., the charging state information about the receiver 200). When the logic level is maintained for one period of the comparison result signal COMP_OUT, the value corresponding to one period of the comparison result signal COMP_OUT may be a first value (e.g., “0”). For example, because the logic level of the comparison result signal COMP_OUT does not change in the first time period TD1, the value of the comparison result signal COMP_OUT corresponding to the first time period TD1 may be the first value. For example, because the logic level of the comparison result signal COMP_OUT does not change in the second time period TD2, the value corresponding to the second time period TD2 of the comparison result signal COMP_OUT may be the first value.

In one or more embodiments, when the logic level is not maintained during one period of the comparison result signal COMP_OUT, the value corresponding to one period of the comparison result signal COMP_OUT may be the second value (e.g., “1”). For example, because the logic level of the comparison result signal COMP_OUT changes from high level to low level in a third time period TD3, a value of the comparison result signal COMP_OUT corresponding to the third time period TD3 may be the second value.

In this specification, the first logic level may refer to a low level, and the second logic level may refer to a high level. However, this is not intended to limit the inventive concept, and of course, the first logic level may be referred to as a high level and the second logic level may be referred to as a low level.

The capacitance of the capacitors constituting the demodulator 140 according to one or more embodiments may be small enough to be integrated into one chip. For example, if the capacitance of the capacitor is 1 nF or higher, it may be difficult to integrate these capacitors into one chip. However, the capacitance of each of the first to fourth capacitors Cd1 to Cd4 included in the demodulator 140 according to one or more embodiments may be configured to be less than 1 nF. In some embodiments, the capacitance of each of the first to fourth capacitors Cd1 to Cd4 may be 1 pF to 30 pF.

According to one or more embodiments, the capacity of the capacitors constituting the demodulator 140 may be reduced, and through this, the components of the demodulator 140 may be mounted on one chip. By mounting the demodulator 140 on one chip, the use of external devices required when designing the demodulator 140 may be reduced. Therefore, according to one or more embodiments, the area occupied by the demodulator 140 may be reduced, and the costs incurred to produce the demodulator 140 may be reduced.

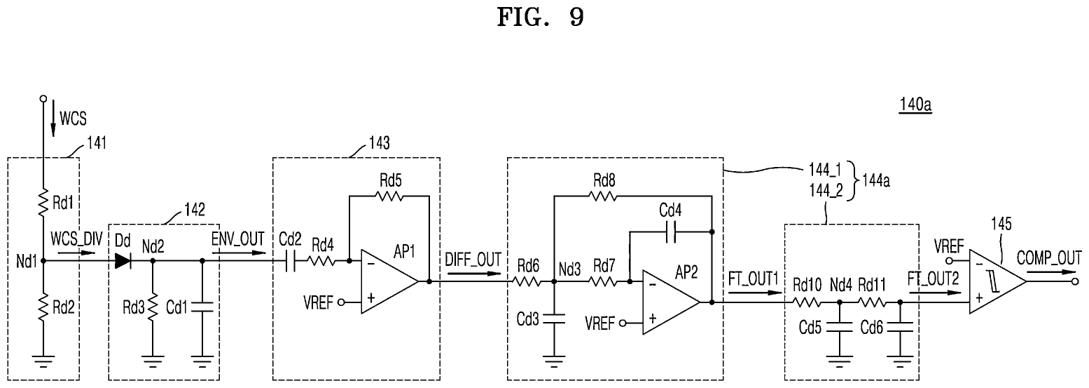

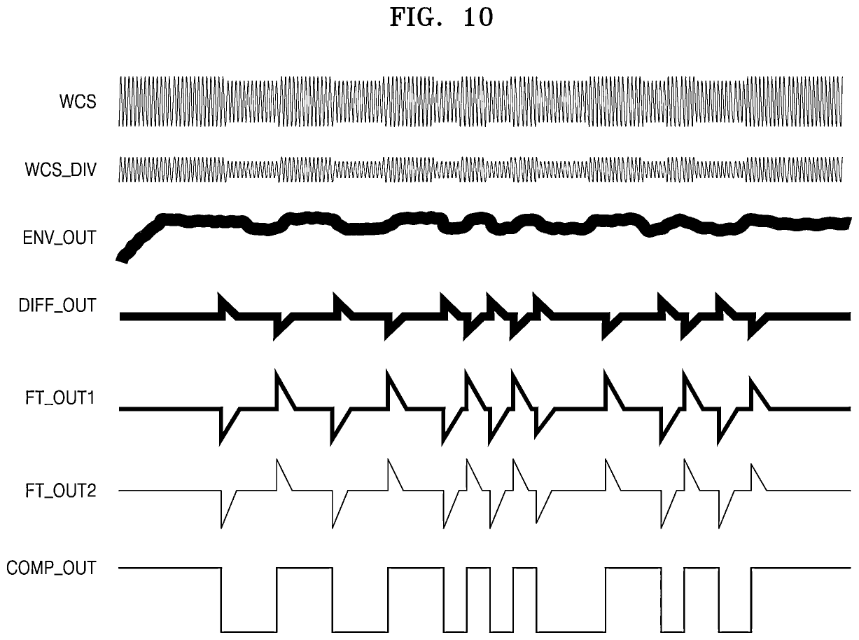

FIG. 9 is a circuit diagram illustrating a demodulator 140a according to one or more embodiments. FIG. 10 illustrates waveforms of signals generated inside the demodulator 140a according to one or more embodiments. FIGS. 9 and 10 may be described with reference to FIGS. 1 to 8, and redundant descriptions may be omitted.

Referring to FIGS. 9 and 10, the demodulator 140a of FIG. 9 may correspond to the demodulator 140 of FIG. 7. However, a filter 144a of the demodulator 140a of FIG. 9 may include a first filter 144_1 and a second filter 144_2. The first filter 144_1 may be the same as or correspond to the filter 144 of FIG. 9.

Because the demodulator 140a of FIG. 9 further includes the second filter 144_2, signals may be filtered more precisely.

The first filter 144_1 may low-pass filter the differential signal DIFF_OUT and output a first filtered signal FT_OUT1, which is an amplified signal.

The second filter 144_2 may receive the first filtered signal FT_OUT1 from the first filter 144_1 and output a second filtered signal FT_OUT2, which is the low-pass filtered signal of the first filtered signal FT_OUT1. The second filter 144_2 may include a tenth resistor Rd10, an eleventh resistor Rd11, a fifth capacitor Cd5, and a sixth capacitor Cd6. One end of the tenth resistor Rd10 may be electrically connected to the output terminal of the second operational amplifier AP2, and the first filtered signal FT_OUT1 may be applied to the one end of the tenth resistor Rd10. The other end of the tenth resistor Rd10 may be electrically connected to a fourth node Nd4. One end of the eleventh resistor Rd11 may be electrically connected to the fourth node Nd4, and the other end of the eleventh resistor Rd11 may be electrically connected to a non-inverting input terminal of the comparator 145. One end of the fifth capacitor Cd5 may be electrically connected to the fourth node Nd4, and the other end of the fifth capacitor Cd5 may be electrically connected to the ground. One end of the sixth capacitor Cd6 may be electrically connected to the non-inverting input terminal of the comparator 145, and the other end of the sixth capacitor Cd6 may be electrically connected to the ground.

The comparator 145 may output a comparison result signal COMP_OUT corresponding to a result of comparing the second filtered signal FT_OUT2 received from the second filter 144_2 with the reference voltage VREF.

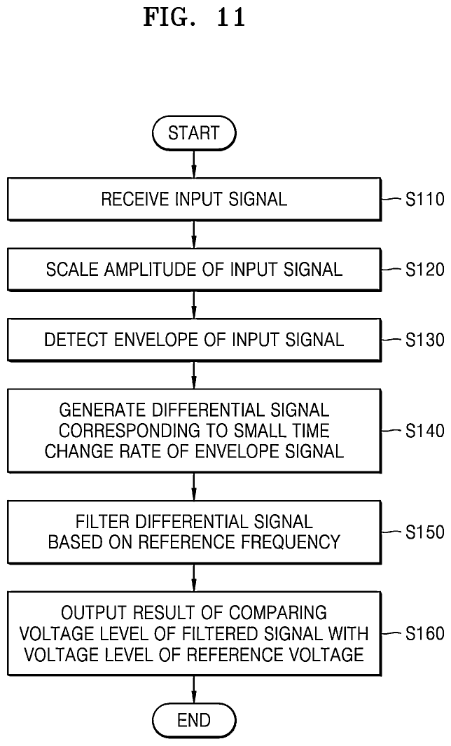

FIG. 11 is a flowchart illustrating an operating method of a wireless power transmission device according to one or more embodiments. FIG. 11 may be described with reference to FIGS. 1 to 10, and redundant descriptions may be omitted.

Referring to FIG. 11, in operation S110, the transmitter 100 may receive a capacitively modulated input signal through the demodulator 140. In one or more embodiments, the input signal may be a capacitively modulated charging signal WCS based on the status signal STS generated by the receiver 200 to provide status information, which includes charging state information about the receiver 200, to the transmitter 100.

In operation S120, the transmitter 100 may scale an amplitude of the received input signal. In one or more embodiments, when the amplitude of the input signal is A, the transmitter 100 may scale the amplitude of the input signal by A/N (N is a real number of 1 or greater).

In operation S130, the transmitter 100 may detect an envelope of the scaled input signal. The transmitter 100 may generate an envelope signal corresponding to the detected envelope.

In operation S140, the transmitter 100 may generate a differential signal corresponding to a small time change rate of the envelope signal. In one or more embodiments, the differential signal may be a differentiator output signal calculated according to Equation 2 described above by using the envelope signal as an input signal of the differentiator.

In one or more embodiments, the transmitter 100 may amplify an magnitude of the differential signal.

In operation S150, the transmitter 100 may filter noise of the differential signal generated in operation S140 based on a reference frequency. The transmitter 100 may invert the differential signal generated in operation S140 and amplify the amplitude of the inverted signal.

In one or more embodiments, the transmitter 100 may perform a low-pass filtering operation to allow only a signal having a frequency lower than the reference frequency to pass therethrough.

In one or more embodiments, the transmitter 100 may perform a filtering operation based on the reference frequency at least twice. For example, as shown in FIG. 9, the transmitter 100 may perform a first low-pass filtering operation through the first filter (144_1 in FIG. 9) and perform a second low-pass filtering operation through the second filter (144_2 in FIG. 9).

In operation S160, the transmitter 100 may generate a comparison result signal corresponding to a result of comparing the signal filtered in operation S150 with the reference voltage and output a generated comparison result signal externally.

In one or more embodiments, the reference voltage may be a voltage generated by the transmitter 100 and may be a voltage applied to the differentiator (143 in FIG. 7), the filter circuit (144 in FIG. 7), and the comparator (145 in FIG. 7) of the transmitter 100.

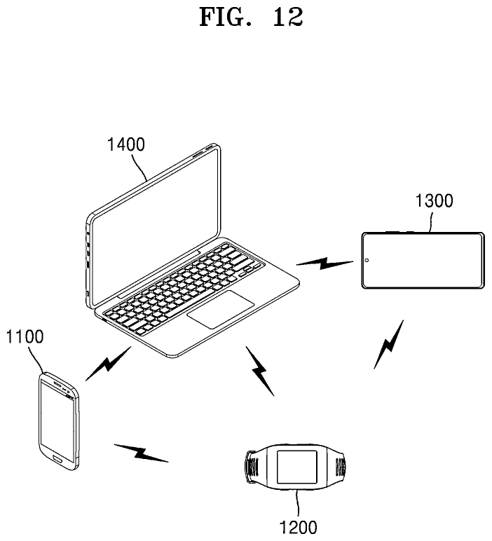

FIG. 12 is a diagram illustrating a method of sharing power between electronic devices, according to various embodiments.

Referring to FIG. 12, electronic devices that may share power may include a smartphone 1100, a wrist-worn electronic device 1200, a tablet PC 1300, and a laptop 1400.

According to an example, at least one of the electronic devices (e.g., 1100, 1200, 1300, and 1400) may perform wireless charging with at least one other electronic device. When at least one of the electronic devices (e.g., 1100, 1200, 1300, and 1400) needs to receive power while an application is running, power may be supplied from an electronic device with available power to the at least one electronic device. Here, the electronic device on the power receiving side may be within a wireless transmission range of the electronic device on the power transmitting side and may receive power wirelessly from the electronic device on the power transmitting side. According to another example, a charging operation may be performed by seating another electronic device on a transmitter included in at least one of the electronic devices (e.g., 1100, 1200, 1300, and 1400). Accordingly, power may be shared between electronic devices without carrying accessories, such as a separate charger, an extra battery, or a charging cable, thereby improving the mobility of electronic devices. In addition, according to various embodiments, not only may power be shared without being limited to a battery type of the electronic device, such as removable or integrated, but also charging is available anytime, anywhere, as long as there is an electronic device that may share power, thereby improving user convenience.

While the disclosure has been particularly shown and described with reference to embodiments thereof, it will be understood that various changes in form and details may be made therein without departing from the spirit and scope of the following claims.

1. An integrated circuit comprising:
a voltage divider circuit configured to receive an input signal and scale a voltage level of the input signal;
an envelope detection circuit configured to detect an envelope of a scaled input signal and output an envelope signal corresponding to the detected envelope of the scaled input signal;
a differentiator circuit configured to differentiate the envelope signal and output a differential signal;
a filtering circuit configured to filter noise of the differential signal based on a reference frequency and output a filtered signal; and
a comparison circuit configured to output a comparison result signal corresponding to the input signal based on a result of comparing a voltage level of the filtered signal with a reference voltage.

2. The integrated circuit of claim 1, wherein:
a logic level of the comparison result signal corresponding to the input signal having a first amplitude is a first logic level,
a logic level of the comparison result signal corresponding to the input signal having a second amplitude is a second logic level, and
the second amplitude is smaller than the first amplitude.

3. The integrated circuit of claim 1, wherein:
the voltage divider circuit includes a first resistor and a second resistor, and
a ratio of a resistance value of the first resistor to a resistance value of the second resistor is N-1 (N is a real number of 2 or greater).

4. The integrated circuit of claim 1, wherein
the differentiator circuit includes a first resistor, a second resistor, a capacitor, and an operational amplifier,
one end of the first resistor is electrically connected to one end of the capacitor,
the other end of the first resistor and one end of the second resistor are electrically connected to an inverting input terminal of the operational amplifier,
the other end of the second resistor is electrically connected to an output terminal of the operational amplifier, and
the reference voltage is applied to a non-inverting input terminal of the operational amplifier.

5. The integrated circuit of claim 1, wherein the filtering circuit is configured to output a filtered signal generated by filtering a frequency component higher than the reference frequency in the differential signal based on the reference frequency.

6. The integrated circuit of claim 1, wherein:
the filtered signal is applied to a non-inverting input terminal of the comparison circuit,
the reference voltage is applied to an inverting input terminal of the comparison circuit,
the comparison circuit is configured to:
output the comparison result signal having a first logic level based on the voltage level of the filtered signal being lower than a first threshold voltage,
output the comparison result signal having a second logic level based on the voltage level of the filtered signal being higher than a second threshold voltage, and
output the comparison result signal based on hysteresis characteristics of the comparison circuit based on the voltage level of the filtered signal being higher than the first threshold voltage and lower than the second threshold voltage,
the first threshold voltage is lower than the reference voltage, and
the second threshold voltage is higher than the reference voltage.

7. The integrated circuit of claim 1, wherein:
based on the comparison result signal maintaining the logic level for one period, a value of the comparison result signal corresponding to the one period of the comparison result signal is a first value, and
based on the logic level of the comparison result signal changing during one period, the value of the comparison result signal corresponding to the one period is a second value.

8. A wireless power transmission device configured to supply wireless power to a wireless power receiving device, the wireless power transmission device comprising:
an inverter circuit configured to generate a charging signal having a first frequency based on a power supply voltage;
a power transmission resonant circuit magnetically coupled to the wireless power receiving device; and
a demodulation circuit configured to receive, as an input signal, the charging signal of which an amplitude changes based on a change in impedance of the wireless power receiving device and output a comparison result signal based on the changed amplitude of the input signal,
wherein the demodulation circuit comprises a differentiator circuit configured to differentiate an envelope signal corresponding to an envelope of the input signal and output a differential signal.

9. The wireless power transmission device of claim 8, wherein:
the inverter circuit comprises a first transistor, a second transistor, a third transistor, and a fourth transistor,
the power transmission resonant circuit comprises an inductor and a capacitor,
a source of the first transistor and a drain of the third transistor are electrically connected to one end of the capacitor,
a source of the second transistor and a drain of the fourth transistor are electrically connected to one end of the inductor,
a drain of the first transistor and a drain of the second transistor are electrically connected to the power supply voltage,
a source of the third transistor and a source of the fourth transistor are electrically connected to ground, and
the other end of the inductor is electrically connected to the other end of the capacitor and the demodulation circuit.

10. The wireless power transmission device of claim 9, wherein the charging signal is generated:
by turning off the second transistor and the third transistor based on the first transistor and the fourth transistor being turned on, and
by turning off the first transistor and the fourth transistor based on the second transistor and the third transistor being turned on.

11. The wireless power transmission device of claim 8, wherein:
based on a resonant frequency of the wireless power receiving device being the first frequency, the amplitude of the input signal is a first amplitude, and
based on the resonant frequency of the wireless power receiving device being a second frequency, different from the first frequency, the amplitude of the input signal is a second amplitude, and
the second amplitude is smaller than the first amplitude.

12. The wireless power transmission device of claim 8, wherein:
the first frequency is higher than a reference frequency, and
a frequency of the comparison result signal is lower than the reference frequency.

13. The wireless power transmission device of claim 8, wherein the demodulation circuit comprises:
a voltage divider circuit including a first resistor and a second resistor; and
the ratio of a resistance value of the first resistor to a resistance value of the second resistor is N-1 (N is a real number of 2 or greater).

14. The wireless power transmission device of claim 8, wherein:
the differentiator circuit comprises a first resistor, a second resistor, a capacitor, and an operational amplifier,
one end of the first resistor is electrically connected to one end of the capacitor,
the other end of the first resistor and one end of the second resistor are electrically connected to an inverting input terminal of the operational amplifier, and
the other end of the second resistor is electrically connected to an output terminal of the operational amplifier.

15. The wireless power transmission device of claim 8, wherein the demodulation circuit comprises a filtering circuit configured to output a filtered signal generated by filtering a frequency component higher than a reference frequency in the differential signal.

16. The wireless power transmission device of claim 15, wherein:
the demodulation circuit comprises a comparison circuit configured to output a comparison result signal corresponding to the input signal based on a result of comparing a voltage level of the filtered signal with a voltage level of a reference voltage,
the filtered signal is applied to a non-inverting input terminal of the comparison circuit,
the reference voltage is applied to an inverting input terminal of the comparison circuit,
the comparison circuit is configured to:
output the comparison result signal having a first logic level based on the voltage level of the filtered signal being lower than a first threshold voltage,
output the comparison result signal having a second logic level based on the voltage level of the filtered signal being higher than a second threshold voltage, and
output the comparison result signal based on hysteresis characteristics of the comparison circuit based on the voltage level of the filtered signal being higher than the first threshold voltage and lower than the second threshold voltage,
the first threshold voltage is lower than the reference voltage, and
the second threshold voltage is higher than the reference voltage.

17. The wireless power transmission device of claim 8, wherein the comparison result signal represents charging state information about the wireless power receiving device.

18. The wireless power transmission device of claim 8, wherein:
based on the comparison result signal maintaining a logic level for one period, a value of the comparison result signal corresponding to the one period of the comparison result signal is a first value, and
based on the logic level of the comparison result signal changing during one period, the value of the comparison result signal corresponding to the one period is a second value.

19. An operating method of a wireless power transmission device configured to supply wireless power to a wireless power receiving device, the operating method comprising:
receiving, as an input signal, a charging signal of which an amplitude changes based on a change in impedance of the wireless power receiving device;
scaling a voltage level of the input signal;
detecting an envelope of the scaled input signal and outputting an envelope signal corresponding to the detected envelope;
differentiating the envelope signal and outputting a differential signal;
filtering the differential signal based on a reference frequency and outputting a filtered signal; and
outputting a comparison result signal corresponding to the input signal based on a result of comparing a voltage level of the filtered signal with a voltage level of a reference voltage.

20. The operating method of claim 19, wherein:
a frequency of the charging signal is a first frequency,
based on a resonant frequency of the wireless power receiving device being the first frequency, an amplitude of the input signal is a first amplitude, and
based on the resonant frequency of the wireless power receiving device being a second frequency, different from the first frequency, the amplitude of the input signal is a second amplitude, and
the second amplitude is smaller than the first amplitude.

21-25. (canceled)
